(19) United States
(12) Patent Application Publication
(10) Pub. No.: US 2019/0377661 A1
(43) Pub. Date: Dec. 12, 2019

(54) INFLUENCE EXTRACTION DEVICE, COMPUTER READABLE MEDIUM AND INFLUENCE EXTRACTION METHOD

(71) Applicant: Mitsubishi Electric Corporation, Chiyoda-ku, Tokyo (JP)

(72) Inventors: Michiyasu HIRAMATSU, Tokyo (JP); Kento NISHITSUJI, Tokyo (JP); Masami IWAHASHI, Tokyo (JP)

(73) Assignee: Mitsubishi Electric Corporation, Chiyoda-ku, Tokyo (JP)

(21) Appl. No.: 16/483,801

(22) PCT Filed: Feb. 27, 2017
(86) PCT No.: PCT/JP2017/007527

§ 371 Date: Aug. 6, 2019

(51) Int. Cl. G06F 11/36

(52) U.S. Cl. CPC G06F 11/3612; G06F 11/3676; G06F 11/3616

(57) ABSTRACT

The influence extraction device includes an output result acquisition unit, a change extraction unit and a search unit. The output result acquisition unit acquires a first output result of a subsystem before a change in a program, and a second output result of the subsystem after the change in the program. The change extraction unit compares the first output result and the second output result, and extracts an interface item whose item value is changed from a plurality of interface items that the subsystem includes. The search unit searches subsystem information for another subsystem including an interface item related to the interface item extracted.

### TECHNICAL FIELD

The present invention relates to an influence analysis of a change in a system or software.

### BACKGROUND ART

The size and complexity of software have been increased due to multi-functionalization of software. Further, there has been an increasing tendency that a plurality of pieces of software and equipment work together to configure one system so that functions having a high additional value are realized, and it is not uncommon to configure one system by combining several dozens to several hundreds of devices and subsystems.

In order to develop software under these circumstances, it has become profoundly important to assess what part of the entire system a change made in a certain device or subsystem influences. If a developer makes a change without recognizing a range of influence correctly, a device or function regarded as irrelevant may malfunction due to mismatch with a specification.

Generally, it is possible to examine the range that a change influences, from a design document on software. However, since a design document is written in a natural language, it is difficult to process the design document automatically, and it is highly possible that it may take much time for manual investigation, and errors may be caused.

Even in a case wherein a unified modeling language (UML) model, etc. being machine processable is included in a design document, the contents of the design document may have a lack or be old, and there is a possibility that correct results cannot be obtained due to mismatch of the contents with the software actually in operation.

As another approach, an effort to specify an influence range by analyzing source codes of software is considered.

Patent Literature 1 provides a user with information for analyzing source codes of software by a computer, and specifying an influence range such as an execution path or dependence of variables, in a flowchart or a tree structure.

Meanwhile, as in Patent Literature 2 and Patent Literature 3, approaches are made to assess validity of a certain subsystem by comparing supposed behaviors of the subsystem obtained by comparison results of an execution result of the past or a design document with respect to a system.

### CITATION LIST

### Patent Literature

Patent Literature 1: JP2013-156786 A

Patent Literature 2: JP2011-060052 A

Patent Literature 3: JP2015-094964 A

### SUMMARY OF INVENTION

### Technical Problem

However, by the techniques of Patent Literature 2 and Patent Literature 3, there is a problem that it is impossible to recognize an influence of change in behaviors of the system obtained on another system.

The present invention is aimed at providing a device possible to indicate an influence of change in a subsystem on another subsystem.

### Solution to Problem

An influence extraction device according to the present invention includes:

an output result acquisition unit to acquire, with respect to one subsystem among a plurality of subsystems forming a system, a first output result being an output result of the one subsystem before a change in a program, and a second output result being an output result of the one subsystem after the change in the program obtained from same input data as the input data from which the first output result is obtained;

a change extraction unit to compare the first output result and the second output result, and based on a comparison result, to extract from a plurality of interface items included in the one subsystem the interface item whose item value is changed; and

a search unit to search subsystem information for another subsystem including an interface item related to the interface item extracted, the subsystem information describing at least one interface item with respect to each subsystem of the plurality of subsystems.

### Advantageous Effects of Invention

Since an influence extraction device of the present invention is equipped with a change extraction unit and a search unit, it is possible to extract a subsystem that is influenced by other subsystems connected to the subsystem based on change information of output of the subsystem. Therefore, it is possible to indicate an influence range of the subsystem whereof the program is changed.

### BRIEF DESCRIPTION OF DRAWINGS

FIG. 1 is a diagram according to a first embodiment, and a diagram illustrating a functional configuration of an influence extraction device 100;

FIG. 2 is a diagram according to the first embodiment, and is a diagram illustrating a hardware configuration of the influence extraction device 100;

FIG. 3 is a diagram according to the first embodiment, and is a sequence diagram illustrating an operation of the influence extraction device 100;

FIG. 4 is a diagram according to the first embodiment, and is a diagram illustrating an operation of a test implementation unit 111 schematically;

FIG. 5 is a diagram according to the first embodiment, and is a diagram illustrating a first output result a(1);

FIG. 6 is a diagram according to the first embodiment, and is a diagram illustrating a second output result a(2);

FIG. 7 is a diagram according to the first embodiment, and is a diagram illustrating definition information 112b;

FIG. 8 is a diagram according to the first embodiment, and is a diagram illustrating an operation of a protocol analyzer 112a;

FIG. 9 is a diagram according to the first embodiment, and is a diagram illustrating subsystem information 122a; and

FIG. 10 is a diagram according to the first embodiment, and is a diagram illustrating an example displayed on a display device 130.

### DESCRIPTION OF EMBODIMENT

### First Embodiment

Hereinafter, an embodiment of an influence extraction device 100 will be described in detail based on diagrams. Note that the present invention is not limited to this embodiment.

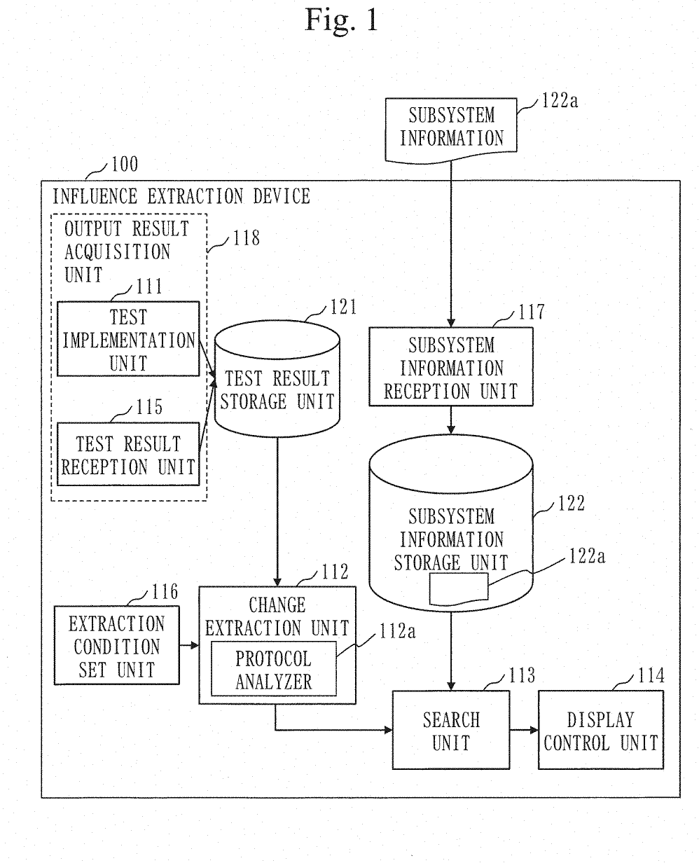

With reference to FIG. 1 through FIG. 10, the influence extraction device 100 will be described.

FIG. 1 illustrates a functional configuration of the influence extraction device 100.

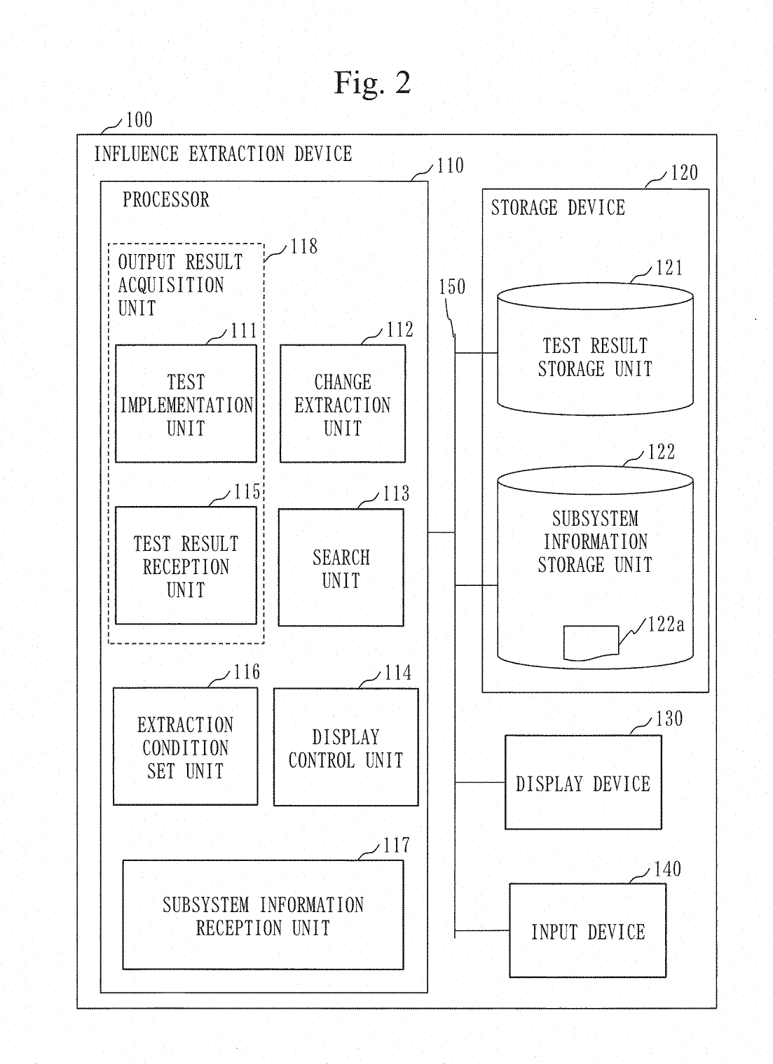

FIG. 2 illustrates a hardware configuration of the influence extraction device 100.

With reference to FIG. 2, the hardware configuration of the influence extraction device 100 will be described. The influence extraction device 100 is a computer. The influence extraction device 100 is equipped with a processor 110, a storage device 120, a display device 130 and an input device 140 as hardware components. The processor 110 is connected to other hardware components via a signal line 150 to control the other hardware components.

The processor 110 is an integrated circuit (IC) to perform arithmetic processing. The processor 110 is, for example, a central processing unit (CPU), a digital signal processor (DSP), or a graphics processing unit (GPU).

The storage device 120 is composed of a volatile main storage unit and a non-volatile auxiliary storage unit. A test result storage unit 121 and a subsystem information storage unit 122 are realized by the storage device 120.

The main storage unit of the storage device 120 is, for example, a static random access memory (SRAM) or a dynamic random access memory (DRAM). The auxiliary storage unit of the storage device 120 is a magnetic disk device. The auxiliary storage unit may be a storage device using a portable storage medium, such as an optical disk, a compact disc, a Blu-ray (registered trademark) disc, and a digital versatile disk (DVD). The auxiliary storage unit stores programs and other data to realize functions of the influence extraction device 100.

The display device 130 is a device to display information by control of a display control unit 114. The display device 130 is, for example, a liquid crystal display.

The input device 140 is, for example, a mouse, a keyboard or a touch panel.

The influence extraction device 100 is equipped with, as functional elements, a test implementation unit 111, a change extraction unit 112, a search unit 113, the display control unit 114, a test result reception unit 115, an extraction condition set unit 116 and a subsystem information reception unit 117. The test implementation unit 111 and the test result reception unit 115 constitute an output result acquisition unit 118. The functions of the test implementation unit 111, the change extraction unit 112, the search unit 113, the display control unit 114, the test result reception unit 115, the extraction condition set unit 116 and the subsystem information reception unit 117 are realized by software. The auxiliary storage unit of the storage device 120 stores a program to realize the functions of the test implementation unit 111, the change extraction unit 112, the search unit 113, the display control unit 114, the test result reception unit 115, the extraction condition set unit 116 and the subsystem information reception unit 117. The program is read and executed by the processor 110. In this manner, the functions of the test implementation unit 111, the change extraction unit 112, the search unit 113, the display control unit 114, the test result reception unit 115, the extraction condition set unit 116 and the subsystem information reception unit 117 are realized.

In FIG. 2, only one processor 110 is illustrated. However, the influence extraction device 100 may be equipped with a plurality of processors replacing the processor 110. The plurality of processors share execution of the program of the test implementation unit 111, the change extraction unit 112, the search unit 113, the display control unit 114, the test result reception unit 115, the extraction condition set unit 116 and the subsystem information reception unit 117. Each processor is an IC to perform arithmetic processing similarly to the processor 110.

The test implementation unit 111 implements a test on a subsystem A whereof a program has been changed. Hereinafter, change means a change in a program with respect to a certain subsystem A. Change means a change in a program. A subsystem A before a change is denoted as a subsystem A(1), and a subsystem A after a change is denoted as a subsystem A(2). When there is no necessity to distinguish between a subsystem A(1) and a subsystem A(2), it is denoted as a subsystem A. Further, an output result of a subsystem A(1) at the time when a scenario 10 below is input is denoted as a first output result a(1), and an output result of a subsystem A(2) at the time when the same scenario 10 is input is denoted as a second output result a(2).

Explanation of Operation

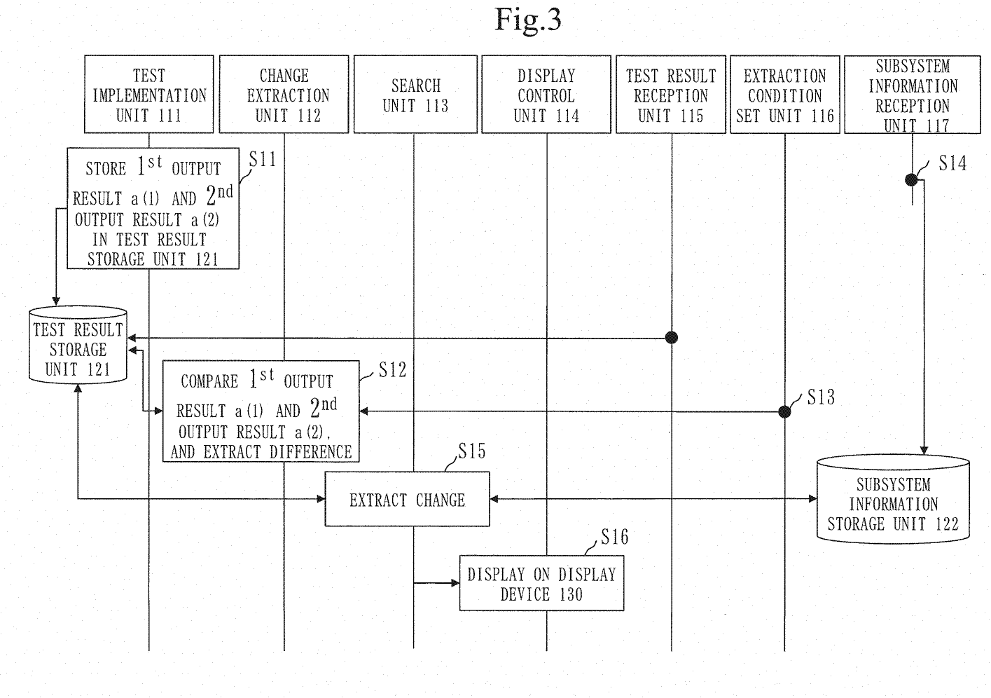

FIG. 3 illustrates an operation of the influence extraction device 100.

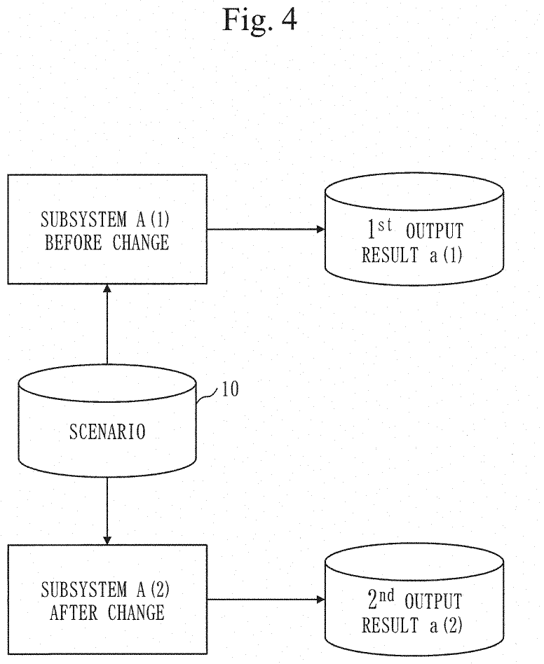

FIG. 4 schematically illustrates an operation of the test implementation unit 111. With reference to FIG. 3 and FIG. 4, an influence extraction method performed by the influence extraction device 100 will be described.

<Test Implementation Unit 111>

The output result acquisition unit 118 is composed of the test implementation unit 111 and the test result reception unit 115. The output result acquisition unit 118 acquires the first output result a(1) being an output result of one subsystem A(1) before a change in a program, and a second output result a(2) acquired as an output result of one subsystem A(2) after the change in the program from the same input data as input data from which the first output result a(1) is obtained, with respect to one subsystem A among the plurality of subsystems composing a system. The same input data as the input data whereby the first output result a(1) is obtained is the scenario 10.

The test implementation unit 111 acquires the first output result a(1) by inputting the scenario 10 being input data to one subsystem A(1) before a change in the program, and making the one subsystem A(1) before the change in the program perform processing, and acquires the second output result a(2) by inputting the same scenario 10 to one subsystem A(2) after the change in the program, and making the one subsystem A(2) after the change in the program perform processing. The test result reception unit 115 receives the first output result a(1) and the second output result a(2) via the input device 140, and stores the first output result a(1) and the second output result a(2) in the test result storage unit 121 being the storage device 120. The details are described below.

When a test is automated, the test implementation unit 111 inputs the scenario 10 in the subsystem A as a test object, and makes the subsystem A perform processing in accordance with the scenario 10. The scenario 10 is data indicating a processing procedure with respect to the subsystem A. The test implementation unit 111 records an output result of the subsystem A in the test result storage unit 121. When a test by the test implementation unit 111 is not automated, a user performs a test operation for the subsystem A, and the test implementation unit 111 records the output result in the test result storage unit 121.

Note that it is possible to replace the test by the test implementation unit 111, by making the test result reception unit 115 receive an output result being a result of a test performed on the subsystem A by a user beforehand, via the input device 140.

The test implementation unit 111 inputs the same scenario 10 with respect to the subsystem A(1) before a change and the subsystem A(2) after the change. In this manner, the first output result a(1) is obtained from the subsystem A(l), and the second output result a(2) is obtained from the subsystem A(2). The test implementation unit 11 records the first output result a(1) and the second output result a(2) obtained. The test implementation unit 111 stores in the test result storage unit 121 the first output result a(1) and the second output result a(2) recorded along with identification information of the subsystem A, as a test result (step S11).

<Change Extraction Unit 112>

The change extraction unit 112 compares the first output result a(1) and the second output result a(2), and from the comparison result, extracts interface items whose item values change, from a plurality of interface items included in the one subsystem A. The details are described below. When the first output result a(1) and the second output result a(2) are stored in the test result storage unit 121, the change extraction unit 112 compares the first output result a(1) and the second output result a(2) stored, and extracts differences for each interface item of two output results (step S12).

The “interface items” are what become interfaces between a certain subsystem and another subsystem. For example, the interface items are port numbers, communication data or states inside the subsystem. The interface items have item values. The item values are data indicating “states of interface items obtained by execution of the scenario 10.” In a case of a port number, as for an input port, item values are whether there is an input or not, and as for an output port, item values are whether there is an output or not. In a case of communication data, as for transmission data, item values are transmission data itself, and as for reception data, item values are reception data itself. In this manner, the interface items may be values that can be directly observed from outside such as a port output, and additionally, the interface items include state values inside a subsystem obtained by using functions of the subsystem A. As described above, communication data is one interface item.

In this case, it is possible for a user to set a kind or a threshold value of outputs that are not extracted as differences even when the outputs are different, by inputting via the extraction condition set unit 116 an extraction condition set by the change extraction unit 112 (step S13). The extraction condition set unit 116 receives via the input device 140 an extraction condition indicating a condition by which the change extraction unit 112 extracts change in an item value, and sets the extraction condition in the change extraction unit 112. The change extraction unit 112 extracts an interface item whereof the item values change in accordance with the extraction condition set. Thus, by setting the extraction condition in the change extraction unit 112 by the extraction condition set unit 116, it is possible to prevent extraction of unnecessary differences.

For example, by ignoring:
(1) An output depending on an environment without substantial impact, such as time information, as an unnecessary difference;
(2) An output that is not input in other subsystems; and
(3) Minute change produced by noise, etc.

and so on, there is an effect that it becomes easy to understand a change produced by a change in a subsystem.

In a case of a value of a port output, etc., the change extraction unit 112 judges existence of a change by whether an obtained value itself is changed or not. The value obtained itself is an item value.

In a case of communication data, the change extraction unit 112 attaches meanings to data included in communication data, and judges whether the value is changed for each meaning, by using a protocol analyzer 112a being a signal analysis device corresponding to a communication protocol used by the subsystem A.

When “temperature” and “pressure” are transmitted by communication, a system to attach temperature and pressure to communication data by a communication protocol is set.

For example, in a protocol definition, it is defined that:

data transmitted after a command identifier “1” denotes temperature, and
data transmitted after a command identifier “2” denotes pressure.

The protocol analyzer 112a interprets communication data based on the protocol definition, and searches the communication data for data of temperature and pressure.

The change extraction unit 112 handles each of the temperature and pressure searched out similarly to handling a value of a port output, etc. sampled at a point of transmission time.

Further, the change extraction unit 112 also extracts difference of a sequence such that a specific command is not transmitted any more, etc., by using pattern recognition and a threshold value, and extracts the difference as an item value of interface items changed.

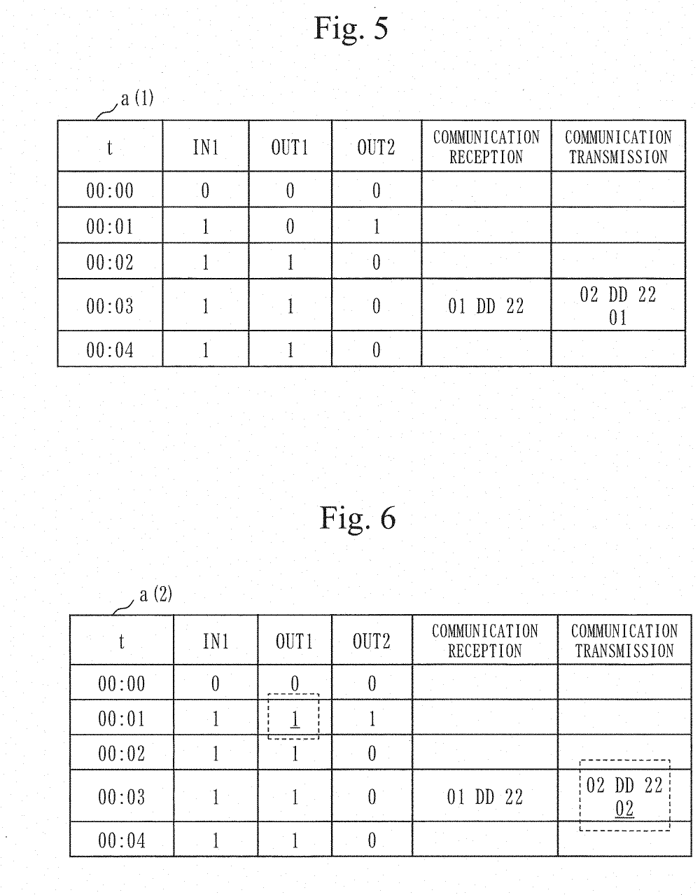

FIG. 5 illustrates the first output result a(1), and FIG. 6 illustrates the second output result a(2). By a comparison between the first output result a(1l) and the second output result a(2), the change extraction unit 112 extracts underlined parts enclosed in broken-line frames in FIG. 6 as differences. The change extraction unit 112 obtains “OUT1” and “communication transmission” as the interface items whereof the item values have changed. In FIG. 5 and FIG. 6, all of IN1, OUT1, OUT2, communication reception and communication transmission are the interface items.

The data of the communication transmission in FIG. 6 is further analyzed by the protocol analyzer 112a.

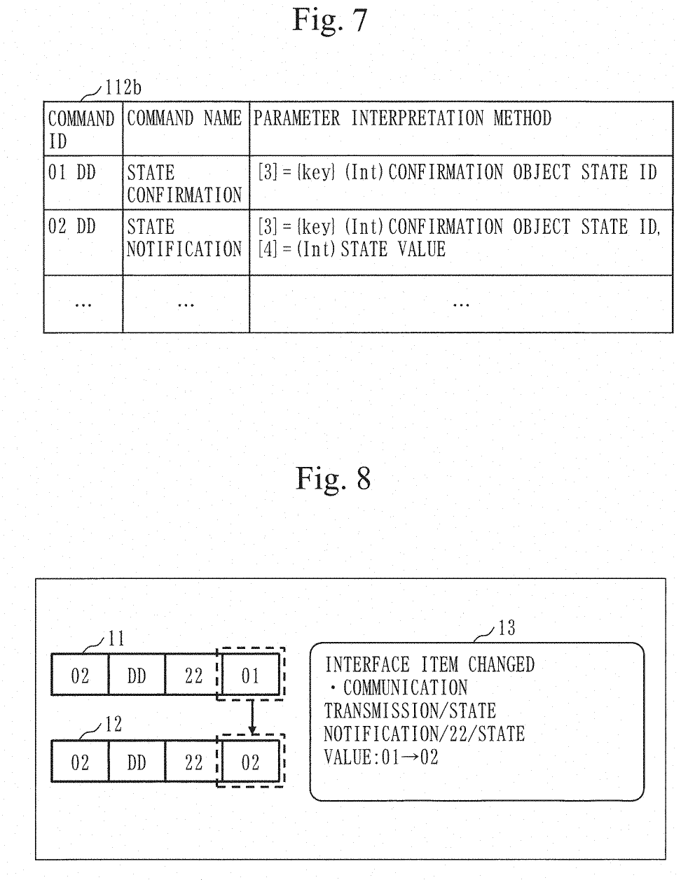

FIG. 7 illustrates definition information 112b of a protocol set for the protocol analyzer 112a.

FIG. 8 illustrates an operation of the protocol analyzer 112a. The protocol analyzer 112a interprets communication data by being provided with definition information 112b interpreting the communication data. When communication transmission data 11 before a change and communication transmission data 12 after the change are compared, the protocol analyzer 112a detects that the fourth data is different. By referring to the definition information 112b, the data is recognized as a state value at the time of a state ID 22 of state notification; hence, the protocol analyzer 112a extracts contents of a display example 13 as interface items changed.

<Subsystem Information Reception Unit 117>

The subsystem information reception unit 117 receives subsystem information 122a via the input device 140, and stores the subsystem information 122a in the subsystem information storage unit 122 (step S14). In the subsystem information 122a, for information representing an entity of a subsystem such as a program module or a model number of a device, interface items being input to the subsystem are listed.

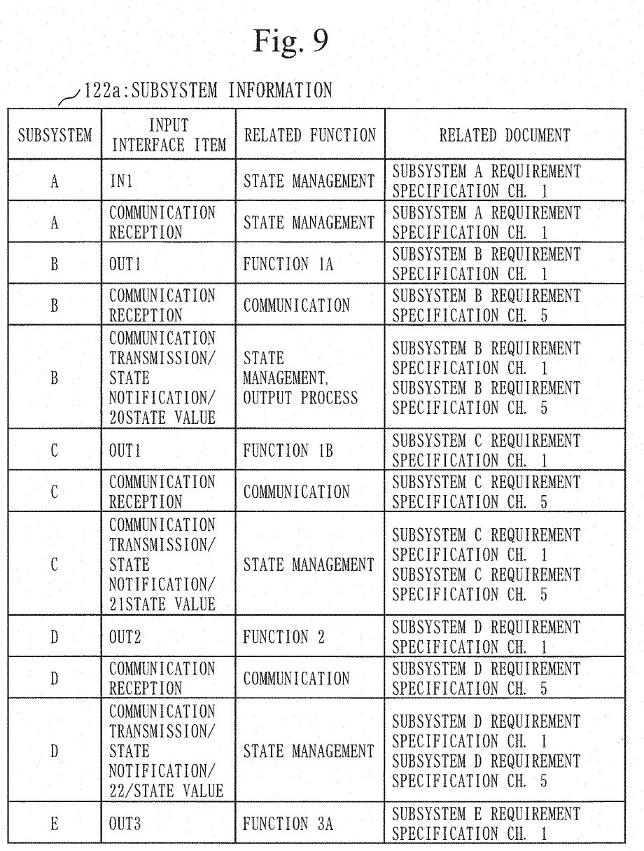

FIG. 9 illustrates the subsystem information 122a. As detailed relation information inside the subsystem with respect to the interface items, at least one of a related function and a related document is associated with the interface items. FIG. 9 illustrates a case wherein both of the related function and the related document are associated with the interface items.

In order to accumulate the subsystem information 122a, it is possible to use information provided by the test implementation unit 111 or the test result reception unit 115. For example, items included in input sequences indicated in the scenario 10 with respect to the subsystem before a change or after the change being the test object by the test implementation unit 111 are used as the interface items.

In this manner, by continuing use of the influence extraction device 100 according to the first embodiment, the information of the subsystem A being the test object is sequentially accumulated in the influence extraction device 100 to be a search object next time or later; hence, extraction becomes easier.

<Search Unit 113>

The search unit 113 searches the subsystem information 122a for another subsystem having interface items related to the interface items extracted by the change extraction unit 112. The subsystem information 122a describes at least one interface item with respect to each subsystem of a plurality of subsystems. The details are described below.

The search unit 113 searches the subsystem information 122a of the subsystem information storage unit 122, and searches out and lists the subsystem to which the interface item whose item value is changed, obtained by the change extraction unit 112, has been related as the input interface item (step S15).

At this time, the search unit 113 lists information of subsystems searched out, in a finer unit, such as in a unit of an internal module, etc., in a case wherein the detailed relation information inside the subsystem is included in the subsystem information 122a.

The display control unit 114 displays the subsystem searched out by the search unit 113 on the display device 130. That is, the search result listed by the search unit 113 is presented on the display device 130 by the display control unit 114 (step S16).

As the search result, for example, a subsystem and an internal module in the subsystem are listed as a list. It is possible to display in the search result a list of interface items whereof the item values are changed, which has caused the items to be listed.

When at least any one of a design document or a test specification associated with the interface items exists in the subsystem information 122a, the search unit 113 also extracts the design document or a test specification. The search unit 113 performs a marking process in a style of a marker, etc. with respect to the related document, and as for the test specification, presents or automatically performs test items.

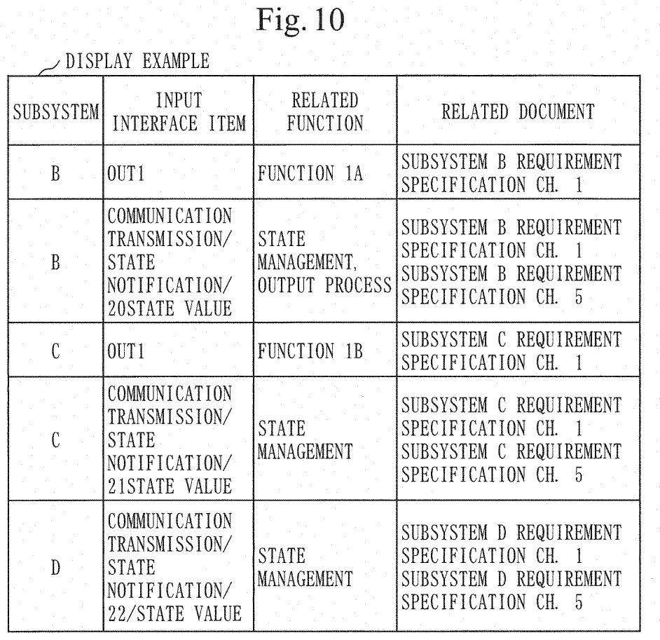

FIG. 10 illustrates a display example displayed on the display device 130 by the display control unit 114. This is a case wherein the change extraction unit 112 extracts that “OUT1,” “communication transmission” and “communication transmission/state notification/22/state value” arc changed. In this case, the search unit 113 searches the subsystem information 122a, and extracts the items illustrated in FIG. 10 respectively set as input interface items.

When a normal development pattern is assumed, there is a case wherein development of subsystems composing a system is performed by dividing the development for each subsystem separately. By assuming such a style, it is also considered to make the test execution result and the subsystem information 122a stored in the test result storage unit 121 of the influence extraction device 100 be shared with another influence extraction device 100. As a sharing method, there is a pattern wherein information of each influence extraction device 100 is shared, or a pattern wherein each influence extraction device 100 is connected by a network.

Note that, as a feature of test implementation in the test implementation unit 111, the influence extraction device 100 only evaluates a change in output, i.e., a change in item values, without evaluating the validity of the output. However, there is a pattern of using the influence extraction device 100 as an automatic test device by conducting evaluation of the validity of output at the same time.

When the validity evaluation of output is not considered, the scenario 10 to be input needs not necessarily be a scenario of a legitimate procedure based on test design. In the scenario 10, input values of input items supposed for a subsystem may be automatically generated in a random manner as far as the subsystem being a test object allows. Even in this case, with respect to the subsystem A(2) after a change being a comparison object, by using the scenario 10 for the subsystem A(1) before a change, it is possible to obtain a comparable output.

### Effect of First Embodiment

As described above, the influence extraction device 100 of the first embodiment automatically detects a change in output response to input when a program of one subsystem is changed among a plurality of subsystems composing a system. Then, the influence extraction device 100 provides a user with information on another subsystem related to the change. Thus, it is possible to search and trace influence of change easily when the program of the subsystem is changed.

<Variation>

In FIG. 2, the functions of the test implementation unit 111, the change extraction unit 112, the search unit 113, the display control unit 114, the test result reception unit 115, the extraction condition set unit 116 and the subsystem information reception unit 117 are realized by the processor 110. However, the functions of the test implementation unit 111, the change extraction unit 112, the search unit 113, the display control unit 114, the test result reception unit 115, the extraction condition set unit 116 and the subsystem information reception unit 117 may be provided by “circuitry.” Note that the test implementation unit 111, the change extraction unit 112, the search unit 113, the display control unit 114, the test result reception unit 115, the extraction condition set unit 116 and the subsystem information reception unit 117 may be replaced with “circuits,” “steps,” “procedures” or “processes.” “Circuits” and “circuitry” are concepts that include not only a CPU, but also other types of processing circuits such as a logic IC, a gate array (GA), an application specific integrated circuit (ASIC) or a field-programmable gate array (FPGA), etc.

The above describes the first embodiment of the present invention, whereas the present invention may be performed by partially combining a plurality of technical matters described in the first embodiment. That is, it is possible to perform the present invention by partially combining two or more technical matters. Note that the present invention is not limited to the embodiment, and various alterations can be made as needed.

### REFERENCE SIGNS LIST

10: scenario; 11: communication transmission data of output result a(1); 12: communication transmission data of output result a(2); 13: display example; 100: influence extraction device; 110: processor, 111: test implementation unit; 112: change extraction unit; 112a: protocol analyzer; 112b: definition information; 113: search unit; 114: display control unit; 115: test result reception unit; 116: extraction condition set unit; 117: subsystem information reception unit; 118: output result acquisition unit; 120: storage device; 121: test result storage unit; 122: subsystem information storage unit; 122a: subsystem information; 130: display device; 140: input device; 150: signal line; A(1): subsystem before change; A(2): subsystem after change; a(1) first output result; a(2): second output result

1. An influence extraction device comprising processing circuitry to:
acquire, with respect to one subsystem among a plurality of subsystems forming a system, a first output result being an output result of the one subsystem before a change in a program, and a second output result being an output result of the one subsystem after the change in the program obtained from same input data as input data from which the first output result is obtained;
compare the first output result and the second output result,
and based on a comparison result, extract from a plurality of interface items included in the one subsystem an interface item whose item value is changed; and
search subsystem information for another subsystem including an interface item related to the interface item extracted, the subsystem information describing at least one interface item with respect to each subsystem of the plurality of subsystems.

2. The influence extraction device as defined in claim 1, wherein the processing circuitry:
receives an extraction condition indicating a condition to extract a change in the item value, via an input device;
sets the extraction condition; and
extracts an interface item whose item value is changed, in accordance with the extraction condition.

3. The influence extraction device as defined in claim 1, wherein the processing circuitry extracts the interface item whose item value is changed, by using a protocol analyzer to analyze a communication protocol used by the one subsystem.

4. The influence extraction device as defined in claim 1, wherein the processing circuitry receives the subsystem information via an input device, and stores the subsystem information in a storage device.

5. The influence extraction device as defined in claim 1, wherein the processing circuitry acquires the first output result by inputting the input data to the one subsystem before the change in the program to cause the one subsystem before the change in the program to perform a process, and acquires the second output result by inputting the same input data to the one subsystem after the change in the program to cause the one subsystem after the change in the program to perform a process.

6. The influence extraction device as defined in claim 1, wherein the processing circuitry receives the first output result and the second output result via an input device, and stores the first output result and the second output result in a storage device.

7. The influence extraction device as defined in claim 1, wherein the processing circuitry displays a subsystem searched out by the search unit on a display device.

8. A non-transitory computer readable medium storing an influence extraction program that causes a computer to execute:
a process to acquire, with respect to one subsystem among a plurality of subsystems forming a system, a first output result being an output result of the one subsystem before a change in a program, and a second output result being an output result of the one subsystem after the change in the program obtained from same input data as input data from which the first output result is obtained;
a process to compare the first output result and the second output result, and based on a comparison result, to extract from a plurality of interface items included in the one subsystem an interface item whose item value is changed; and
a process to search subsystem information for another subsystem including an interface item related to the interface item extracted, the subsystem information describing at least one interface item with respect to each subsystem of the plurality of subsystems.

9. An influence extraction method comprising:
by a computer, acquiring, with respect to one subsystem among a plurality of subsystems forming a system, a first output result being an output result of the one subsystem before a change in a program, and a second output result being an output result of the one subsystem after the change in the program obtained from same input data as input data from which the first output result is obtained;
by a computer, comparing the first output result and the second output result, and based on a comparison result, extracting from a plurality of interface items included in the one subsystem an interface item whose item value is changed; and
by a computer, searching subsystem information for another subsystem including an interface item related to the interface item extracted, the subsystem information describing at least one interface item with respect to each subsystem of the plurality of subsystems.
